(19) United States
(12) Patent Application Publication
(10) Pub. No.: US 2025/0272600 A1
(43) Pub. Date: Aug. 28, 2025

(54) Blockchain-Based System and Method for Secure Authentication of Training Data for Machine Learning Models

(71) Applicant: Bank of America Corporation, Charlotte, NC (US)

(72) Inventor: Shailendra Singh, Thane West (IN)

(21) Appl. No.: 18/585,464

(22) Filed: Feb. 23, 2024

(51) Int. Cl. G06N 20/00

(52) U.S. Cl. CPC G06N 20/00

(57) ABSTRACT

The disclosed system includes a memory and a processor designed to execute operations for generating non-fungible tokens for training data utilized in training machine learning models. The memory is configured to store both data records of the training data and their corresponding metadata. The processor performs operations to identify a set of fields within each data record and to annotate each field. Such annotation process involves creating field metadata, including information that identifies each field in the data record and assigning a label to each field. Additionally, for each field, the processor is further configured to generate a non-fungible token and create a non-fungible token attribute record, incorporating details from both the data record metadata and the field metadata. Also, the processor is configured to store the non-fungible token attribute record in the memory, thereby facilitating comprehensive and secure authentication of data records.

### TECHNICAL FELD

The present disclosure relates generally to data security, and more specifically to a blockchain-based system and method for secure authentication of training data for machine learning models.

### BACKGROUND

Artificial Intelligence (AI) data poisoning attacks involve manipulating the training data for training machine learning models to compromise performance or behavior of such machine learning models. During AI data poisoning attacks, alterations to the training dataset may be subtle, making it challenging to detect these manipulations during the model training phase. The transferability of poisoned models also poses an issue. Once a model is successfully poisoned, it may transfer its compromised behavior to various applications and scenarios. This raises the risk of widespread and cascading effects as the poisoned model is deployed in different contexts, amplifying the impact of the initial attack. Moreover, the evolving nature of AI models introduces another layer of complexity. As models are continuously updated and retrained, poisoned data can persist and adapt, posing an ongoing threat. The challenge is not only in securing models against initial poisoning but also in developing mechanisms for detecting and mitigating the impact of poison over time.

### SUMMARY

The disclosed system and method described in the present disclosure is particularly integrated into a practical application of increasing the security of the training data for training machine learning models. The current system and method use a secure authentication for the training data utilizing a blockchain network.

The present disclosure contemplates a system and method for identifying data fields within data records of the training data and generating non-fungible tokens (NFTs) corresponding to the identified data fields. Such NFTs are then stored in a memory and recorded on a blockchain.

In an example embodiment, the disclosed system includes a memory configured to store a data record and metadata associated with the data record and a processor operably coupled to the memory. The processor is configured to identify a set of fields within the data record and annotate each one of the set of fields by generating for each field in the set of fields a field metadata. The field metadata includes information identifying each field within the data record and a label for that field. Further, for each field in the set of fields, the processor is configured to generate a non-fungible token (NFT) and generate an NFT attribute record including information obtained from the data record metadata and the field metadata. Further, the processor is configured to store in the memory the NFT attribute record. In some embodiments, the system is configured to transmit the NFT to be recorded on a blockchain.

The disclosed system improves the security of the training data for training machine learning models by using authentication for the training data, thus reducing the likelihood of AI data poisoning attacks. For example, by implementing the disclosed system, the manipulated training data cannot be used for machine learning model training, as any alterations to the training data, no matter how subtle, compromise its authenticity, thereby rendering the modified training data unsuitable for model training.

The disclosed system and method, designed to mitigate the likelihood of AI poisoning attacks, holds practical significance across diverse sectors, including cybersecurity, clinical services, autonomous vehicles, energy and utilities, education, and emerging technologies such as the Internet of Things (IoT), among other things.

In the realm of cybersecurity, the mitigation of AI poisoning attacks is important for safeguarding sensitive data, critical infrastructure, and network communications.

In clinical services, machine learning models are utilized for tasks such as diagnosis and imaging analysis. The mitigation of AI poisoning attacks in this context preserves the accuracy of diagnostic models, leading to reliable and secure clinical outcomes.

Similarly, in the automotive industry, machine learning models are employed for autonomous vehicles to make real-time decisions based on sensor data. The mitigation of AI poisoning attacks is important to guarantee the safety of passengers and pedestrians, as any compromise in the decision-making process could potentially lead to accidents.

Additionally, machine learning models may be integrated into critical infrastructure and IoT systems for predictive maintenance and efficient operations. Reducing a likelihood of AI poisoning attacks becomes important in maintaining the reliability and security of these systems, thereby reducing disruptions and potential damage. Thus, the practical applications of the disclosed system and method extend across various sectors, underscoring the importance of reducing AI poisoning attacks in ensuring the security, reliability, and accuracy of machine learning models in different industries and technological domains.

Further, using NFTs for mitigating AI poisoning can enhance the functioning of a computer by providing an improved data integrity and data anti-tampering mechanisms, accountability for the training data, secure training environment, as well as compliance to training procedures.

For data integrity, NFTs can be used to authenticate and verify the integrity of training data used to train AI models. By associating NFTs with specific datasets or data records, any unauthorized alterations or tampering can be detected, ensuring the integrity and reliability of the data used for training AI algorithms. Further, NFTs can serve as digital fingerprints or signatures for datasets, making it difficult for attackers to manipulate or poison training data without detection. Any attempts to modify or inject malicious data into the dataset can be flagged through the verification of NFTs associated with the data, thereby reducing a likelihood of AI poisoning attacks.

Additionally, NFTs provide a transparent and immutable record of ownership and provenance for datasets. By tracking the ownership and usage history of datasets through NFTs, it becomes easier to attribute responsibility in case of data breaches or unauthorized modifications. This accountability discourages malicious actors from attempting AI poisoning attacks.

Furthermore, integrating NFTs into AI training pipelines can establish a secure and trustworthy environment for data ingestion, processing, and model training. By verifying the authenticity and integrity of training data using NFTs at each stage of the pipeline, organizations can mitigate the risk of AI poisoning and ensure the reliability of AI models.

Additionally, NFTs enable organizations to demonstrate compliance with regulatory requirements and industry standards for data integrity and security. The transparent and auditable nature of NFTs facilitates compliance audits and regulatory oversight, providing assurance to stakeholders regarding the integrity of AI systems and the data used to train them.

The disclosed system and method enhance the efficiency of processing, memory, and network resources by mitigating the computational demands associated with mitigating AI poisoning attacks. It accomplishes this by streamlining the handling of training data-ensuring its authenticity eliminates the processing contaminated data and reduces computational overhead during training. This, in turn, expedites model convergence, minimizing the iterations and computations that may be required for accuracy and, thereby conserving computational resources.

The mitigation of poisoning attacks further diminishes the frequency of model retraining, saving computational resources typically expended in repetitive training cycles. Additionally, it promotes simplicity in model design, reducing computational requirements across training, deployment, and inference phases. Models free from poisoning attacks also demand fewer computational resources for anomaly detection, avoiding complexities induced by malicious data. During the inference phase, such models operate with reduced computational overhead, possibly eliminating elaborate defenses or additional processing steps. This reduced threat of AI poisoning attacks enables more focused and efficient allocation of computational resources to tasks like model optimization, feature engineering, and exploring advanced algorithms, contributing to overall improvements in the machine learning workflow. Thus, the mitigation of AI poisoning attacks results in a more streamlined and resource-efficient machine learning ecosystem, fostering enhanced performance, faster convergence, and lower computational overhead throughout various phases of the machine learning lifecycle.

Some embodiments of this disclosure may include various aspects of the system and method that will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, where like reference numerals represent like parts.

FIG. 1A illustrates an embodiment of training data generation and distribution operating environment, according to an embodiment.

FIG. 1B is a diagram illustrating an example method of identifying fields within a data record and generating NFTs for the identified fields, according to an embodiment.

FIGS. 2A-2D illustrate example fields within a data record, according to an embodiment.

FIG. 3 illustrates another example of fields within a data record, according to an embodiment.

FIG. 4 illustrates various metadata records that can be associated with an NFT attribute record, according to an embodiment.

FIGS. 5A and 5B illustrate example field and data record mappings that facilitate the determination of suitable training data for a machine learning model, according to an embodiment.

FIG. 6 illustrates an example method for identifying and annotating fields within a data record, and generating NFTs associated with these fields, according to an embodiment.

### DETAILED DESCRIPTION

Various embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” can also be used herein.

### System for Secure Authentication and its Operating Environment

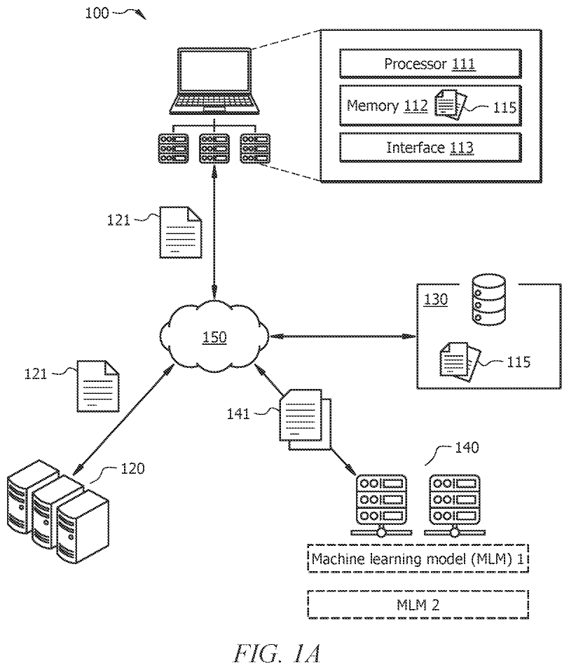

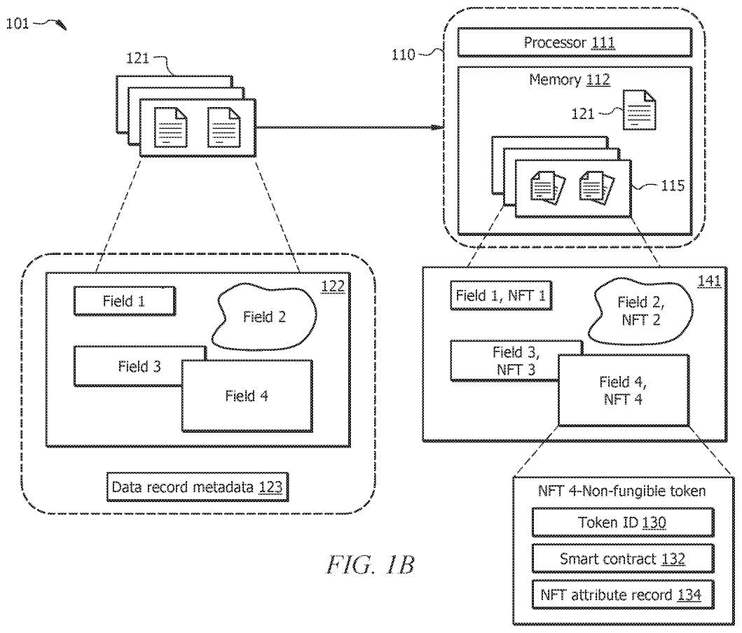

FIG. 1A illustrates a training data generation and distribution operating environment 100 of a system 110 for generation of authentic training data, in accordance with one embodiment of the present disclosure. Operating environment 100 also includes a training data supply system 120, a storage system 130 and an authentic training data demand system 140. In various embodiments, systems 120-140 are configured to communicate with system 110 via a network 150.

System 110 may be any suitable computing system configured to process data and communicate with other systems 120-140. For example, system 110 may include servers (e.g., webservers, application servers, file servers, database servers, and the like), databases, cloud computing system, edge computing systems, or any other suitable systems for data processing. In certain instances, system 110 can include workstations, PCs, portable computers, handheld devices, mobile computing devices, one or more virtual computing machines or instances within a data center, and/or network computers.

System 110 includes a processor 111 in signal communication with a memory 112 and an interface 113. It should be noted that while a single processor 111, single memory 112, and a single interface 113 is shown in FIG. 1A, multiple processors, multiple memory devices, and in some cases, multiple interfaces can be used by system 110. For example, when system 110 includes blade servers, each blade server may have multiple processors, a dedicated memory associated with the blade server, as well as blade server associated interface for communicating data with various other devices.

In various embodiments, processor 111 of system 110 is operably coupled to the memory 112. Processor 111 can include any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). Further, processor 111 may include a programmable logic device, a microcontroller, a microprocessor, a graphics processing unit (GPU), a digital signal processor, or an ARM processor.

A memory 112, may be any suitable memory associated with system 110 for digitally storing data and instructions for execution by the processor 111. Memory 112 may include volatile memory, such as various forms of random-access memory (RAM) or other dynamic storage devices, serving to store temporary variables during instruction execution. The stored instructions, accessible to the processor 111 in non-transitory computer-readable storage media, transform the computer system 110 into a special-purpose machine tailored for executing the specified operations.

Further, memory 112 may include non-volatile memory, such as read-only memory (ROM) or other static storage devices linked to the processor 111 via suitable internal I/O system. Further, memory 112 may include any suitable non-transitory computer-readable medium, such as non-volatile RAM (NVRAM) like FLASH memory, solid-state storage, magnetic disk, or optical disk such as CD-ROM or DVD-ROM, and the like. Non-transitory computer-readable medium may serve to store instructions and data that, when executed by processor 111, cause the execution of computer-implemented methods as detailed herein.

The instructions residing in memory 112 may form one or more sets of organized modules, methods, objects, functions, routines, or calls. These instructions might represent computer programs, operating system services, or application programs, including mobile apps. They may comprise an operating system and/or system software, libraries supporting multimedia or programming functions, data protocol instructions, file format processing instructions, user interface instructions, or application software. The instructions could implement a web server, web application server, web client, or be structured as a presentation layer, application layer, and data storage layer, such as a relational database system using structured query language (SQL) or no SQL, an object store, a graph database, a flat file system, or other data storage.

Processor 111 may be connected via internal I/O system to interface 113. Interface 113 may be any suitable application, application programming interface (API) or web interface for exchanging data with various other systems, such as systems 120-140, as shown in FIG. 1A. In some cases, interface 113 may be a website configured to allow a user associated with training data supply system 120 to upload training data 121 for training a machine learning model or to allow a user associated with authentic training data demand system 140 to download authentic training data 115 for training a machine learning model (MLM). In one embodiment, authentic training data denotes training data that is verifiable as genuine, indicating that it has not been tampered with.

In various embodiments, system 110 is designed to receive training data 121, process it, and subsequently generate authentic training data 115 based on this processing. Authentic training data 115 is then stored within memory 112 of system 110 and may also be transmitted to storage system 130 for further storage. Additional details regarding the processing of training data 121 and the generation of authentic training data 115 are discussed in the following sections, particularly in connection with FIG. 1B.

As shown in FIG. 1A, system 110 may be configured to communicate data with a storage system 130. In various embodiments, storage system 130 can be configured to store various data processed by system 110, as well as any other data that can be used by any other systems in operating environment 100. Similar to system 110, storage system 130 may be any suitable computing system configured to store data and communicate data with other systems 110, 120, and 140. For example, storage system 130 may include various servers, databases, cloud computing systems, edge computing systems, or any other suitable systems for data storage and data communication.

In some cases, the storage system 130 may include a blockchain system (or interact with a blockchain system) configured to effectively implement blockchain technology. The blockchain system may consist of a plurality of interconnected nodes, each equipped with processing capabilities and storage resources. These nodes collaborate to maintain a distributed ledger, facilitating secure and transparent transactions among them. Additionally, the blockchain system may incorporate cryptographic algorithms and consensus mechanisms to ensure data integrity and consensus among the nodes.

Various components and functionalities of the blockchain system can be effectively leveraged to implement Non-Fungible Tokens (NFTs) for generating authentic training data 115. For example, the distributed ledger may be configured to store each NFT represented by a unique digital token. The immutable nature of the ledger ensures that the ownership and transaction history of each NFT are transparent and tamper-proof, providing authenticity and provenance verification for digital assets.

Furthermore, the blockchain system may provide smart contract functionality represented by programmable code deployed on the blockchain, enabling the creation, issuance, and management of NFTs in a decentralized manner. Smart contracts can define the rules and properties of NFTs, including ownership rights, transferability, royalties, and metadata storage. By deploying smart contracts, various aspects of NFT lifecycle management can be automated, such as generation and verification of NFTs.

Additionally, the blockchain system can provide cryptographic security techniques such as digital signatures and cryptographic hashing to secure NFT transactions and ensure data integrity. Each NFT is associated with cryptographic keys that provide ownership control and authorization for transferring the token. Additionally, cryptographic hashes are used to uniquely identify NFTs and link them to their corresponding metadata that can be stored off-chain. The blockchain system also provides consensus mechanisms ensuring agreement among network participants on the validity of NFT transactions and the state of the blockchain. By reaching consensus through mechanisms like proof of work (PoW), proof of stake (PoS), or other consensus algorithms, blockchain networks maintain the integrity and consistency of NFT ownership records across distributed nodes.

In some cases, the blockchain system can facilitate a seamless exchange and interaction of NFTs across different platforms and ecosystems via providing interoperability standards such as ERC-721 and ERC-1155 on Ethereum, or via any other blockchain-specific token standards. These standards define common interfaces and functionalities for NFTs, enabling interoperability between various NFT marketplaces, wallets, and applications. Furthermore, the blockchain system can provide scalability solutions such as Layer 2 protocols, sidechains, or sharding techniques allowing the blockchain system to process a higher volume of transactions without compromising performance or cost-effectiveness.

In some cases, the blockchain system may be one of the available blockchain systems such as Ethereum, Binance Smart Chain, or any other suitable blockchains that can be used for recording NFTs.

As shown in FIG. 1A, operating environment 100 incudes training data supply system 120 configured to supply training data 121 for training various machine learning models (MLMs). Any suitable data can be used for training various MLMs such as images including visual information in the form of pixels arranged in a grid, tabulated data (e.g., data organized in rows and columns, commonly stored in formats such as comma-separated values files or relational databases), text data consisting of unstructured textual information, such as articles, emails, social media posts, and documents, audio data, such as sound waveforms captured over time, typically represented as digital audio signals, time series data representing observations collected at regular intervals over time, such as stock prices, weather measurements, or sensor readings, spatial data representing geographic or spatial information, such as maps, GPS coordinates, or satellite images, graph data representing relationships between entities in the form of nodes and edges, such as social networks, knowledge graphs, and citation networks, three-dimensional modeling data, or any other suitable data for training MLMs.

In particular, training data 121 may include images of various objects that can be used for training one or more MLMs for identifying such objects. Training data supply system 120 may be any suitable system for providing training data 121 and for communicating training data 121 to system 110 via network 150. For example, training data 121 may include one or more servers, databases, and the like. In some cases, training data supply system 120 may be a distributed cloud-based computing system or may include several cloud-based computing systems.

Further, operating environment 100 incudes authentic training data demand system 140 configured to request one or more authentic training records 141 from authentic training data 115. authentic training data demand system 140 may be a system configured to train one or more MLMs. For example, authentic training data demand system 140 may be a system hosting a particular MLM and providing an infrastructure for training that MLM. For instance, authentic training data demand system 140 may include adequate hardware resources for supporting the computational demands of the MLM. Such hardware resources may include a Central Processing Unit (CPU), and/or a Graphics Processing Unit (GPU), or specialized AI accelerator chips (e.g., TPUs or FPGAs) for training and inference tasks. Further, the hardware resources may include a suitable RAM and storage capacity for storing model parameters, intermediate results, and datasets.

Authentic training data demand system 140 also is configured to have software frameworks and libraries installed to develop, train, and deploy one or more MLMs. Popular frameworks such as TensorFlow, PyTorch, scikit-learn, and Keras may provide extensive support for various machine learning tasks and algorithms. Additionally, runtime environments such as Docker or Kubernetes may be used to containerize and manage the execution of machine learning applications. Furthermore, authentic training data demand system 140 may be capable of processing and preprocessing data for training and inference tasks (such as authentic training records 141). This may involve data ingestion, cleaning, transformation, feature engineering, and normalization steps to prepare the data for input into the one or more MLMs. Distributed data processing frameworks like Apache Spark or Dask may be employed for handling large-scale datasets efficiently.

For training machine learning models, authentic training data demand system 140 may have access to scalable computing resources, such as high-performance CPUs or GPUs, distributed computing clusters, or cloud-based services (e.g., AWS SageMaker, Google Colab, or Microsoft Azure Machine Learning). These resources enable parallelized training of complex models on large datasets, reducing training time and improving model performance.

Furthermore, after MLMs are trained, authentic training data demand system 140 can facilitate deployment of such MLMs for handling inference requests from end-users or applications. For example, authentic training data demand system 140 may employ load balancing and auto-scaling to manage incoming inference requests and ensure high availability and scalability of the serving infrastructure.

Additionally, authentic training data demand system 140 may incorporate monitoring and logging capabilities to track the performance and behavior of deployed machine learning models in real-time. Metrics such as inference latency, throughput, accuracy, and error rates are monitored to detect anomalies, optimize resource utilization, and troubleshoot issues promptly. Logging frameworks like ELK (Elasticsearch, Logstash, Kibana) or Prometheus are commonly used for centralized logging and monitoring.

Furthermore, authentic training data demand system 140 may incorporate security measures to protect the confidentiality, integrity, and availability of sensitive data and machine learning models hosted on the system. This includes access control mechanisms, encryption techniques, secure communication protocols (e.g., HTTPS), and compliance with regulatory requirements (e.g., GDPR or HIPAA) governing data privacy and security.

In various embodiments, authentic training data demand system 140 is configured to submit a request to system 110 to obtain one or more authentic training records 141 from the authentic training data 115.

In various cases, authentic training data demand system 140 may be configured to submit a request to system 110 to register various MLMs supported by authentic training data demand system 140. For instance, upon a request from authentic training data demand system 140, system 110 may register MLM 1 and MLM 2 in a way that ensures only the specific training data authenticated for each respective MLM is permitted to be transmitted for training that particular model.

For instance, when requesting training data for a target machine learning model such as MLM 1, authentication credentials are initially transmitted from the authentic training data demand system 140 to system 110. Subsequently, system 110 is configured to select one or more authentic training records that MLM 1 has permission to access. These authentic training records might not be accessible for training MLM 2, requiring MLM 2 to undergo a separate authentication process with system 110 to acquire different authentic training records. Note that in certain instances, permissions for accessing training records may be configured to allow certain authentic training records to be accessible by both MLM 1 and MLM 2.

In various embodiments, when authentic training records 141 are generated, at least some of these records may be designated for a specific MLM (Machine Learning Model). For example, at least some authentic training records may be mapped to a particular identifier of a particular MLM, thereby allowing only such authentic training records to be used for training that particular MLM. Moreover, the construction of authentic training records of authentic training data 115 is designed in a way that any modification of these records render these records unusable for training that particular MLM. In some instances, this functionality extends to various MLMs supported by the authentic training data demand system 140. For example, altered authentic training records may become unusable by any of the MLMs supported by authentic training data demand system 140.

As shown in FIG. 1A, operating environment 100 incudes a network 150 for supporting communication between systems 110-140. Network 150 may be any suitable type of wireless and/or wired network. Network 150 may or may not be connected to the Internet or public network. Network 150 may include a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMax, etc.), a long-term evolution (LTE) network, a universal mobile telecommunications system (UMTS) network, a peer-to-peer (P2P) network, a Bluetooth network, a near field communication (NFC) network, and/or any other suitable network. Network 150 may be configured to support any suitable type of communication protocol as would be appreciated by one of ordinary skill in the art.

### Processes for Generating Authentic Training Data

In various embodiments, system 110 is designed to receive training data 121 and generate authentic training data 115. Authentic training data 115 is configured to be verifiably genuinely sourced, accurate, reliable, and suitable for training machine learning models specifically authenticated to utilize this data.

FIG. 1B is a diagram 101 that illustrates a process of generating authentic training data 115 from training data 121 comprising images of objects. Training data 121 may include multiple data record. A data record, such as data record 122 shown in FIG. 1B, may include an image having several fields labeled as Field 1 through Field 4 (referred to herein as Fields 1-4). It's worth noting that while the discussion primarily revolves around data records corresponding to images and fields being regions of these images, there are situations where data records include data other than images. For instance, such data records may include documents, tables containing alphanumeric values, and similar data forms. In such cases, the identification of fields extends beyond regions within an image to include various elements within these alternative data types.

FIG. 1B shows that for data record 122, Fields 1-4 correspond to objects or specific elements present within data record 122. Such fields can be used for training one or more MLMs to recognize these objects or elements within data record 122. Objects within data record 122 may include any suitable physical, or natural objects such as people, animals, household objects, tools, machines, and similar entities. Conversely, elements may include materials like water, areas such as a sunset sky, textual components, lines or shapes, shadows or reflections, textures or patterns, backgrounds, foregrounds, elements distinguished by their transparency or opacity, or any other image-related components (e.g., elements of specific colors). A data record, such as data record 122 is configured to have an associated data record metadata 123, as shown in FIG. 1B. In various embodiments, upon receiving data record 122 by system 110, memory 112 of system 110 is configured to store data record 122 as well as data record metadata 123.

Data record metadata 123 may include any suitable information associated with data record 122. For example, data record metadata 123 may include a data record source information, (e.g., the data record source information may be a name of an image creator, or a name of an organization or a database from which the image was obtained), a data record identifier (ID), which may be any suitable numerical, alphanumerical or text identifier, a data record file size, and a date and time when the data record was created. Further, for image data records, data record metadata 123 may include an image format (e.g., it could be a bitmap image format like JPEG, TIFF, or GIF, or a vector image format such as PDF or SVG), an image resolution, a color depth (e.g., the number of bits used to represent the color of each pixel in the image), a location description corresponding to the image, image creator details, or keywords associated with the image (e.g., keywords associated with objects shown in the image).

In various embodiments, a set of fields such as Fields 1-4 may be first generated by specifying a boundary around respective objects or elements within the image of data record 122. For convenience and without loss of generality, “data record 122” and “image of the data record 122” are used interchangeably herein. A “field” is understood as a region within the data record 122, thus, equating to a region within the image.

It should be noted that while four fields are shown in FIG. 1B, any number of suitable fields can be used. For example, a single field may be generated for a data record, thereby identifying a single object. Alternatively, a large number of fields (e.g., more than ten fields) may be generated for a data record identifying multiple elements within the data record that can be used for training an MLM.

The extend of objects or elements within a data record can be established through various methods. One approach involves third-party preparation of training data 121, possibly facilitated by the training data supply system 120. In this scenario, human operators may contribute to generating object boundaries. For example, a user can select a rectangle around an object within the data record, or select a cuboid, a polygon, or any suitable closed or partially closed curve to define the boundary. In various embodiments, the boundary provides the information for identifying the field. Such boundary is configured to separate pixels defining a portion of the data record corresponding to the field from pixels defining a portion of the data record that does not correspond to the field.

In some cases, instead of defining a boundary, information for identifying a field may include a semantic segmentation or a line annotation. The semantic segmentation involves partitioning an image into multiple segments or regions, each corresponding to a specific semantic category. Unlike object detection, which identifies objects within an image and outlines their boundaries with bounding boxes, semantic segmentation assigns a class label to every pixel in the image, effectively segmenting it into meaningful parts based on semantic understanding. In semantic segmentation, the goal is to accurately label each pixel with the corresponding class or category, such as person, car, road, building, tree, etc. This fine-grained understanding of the image enables more detailed scene understanding and analysis. The line annotation, on the other hand, can be used to mark or outline specific features or objects in an image using lines or curves. In object detection tasks, lines can be drawn around the boundaries of objects of interest within an image. These lines serve to define the extent and shape of the objects, allowing a machine learning model to learn to recognize and localize them accurately.

Additionally, or alternatively, the extend of objects or elements within an image data can be determined via suitable image processing algorithms that may be executed by processor 111 of system 110. For example, processor 111 may rely on predefined rules or criteria to detect and recognize objects based on specific characteristics or patterns present in an image. Such rule-based approaches may involve segment images based on intensity levels or color values, separating objects from the background. Such approach is referred herein as a thresholding method, and it may involve setting a fixed threshold value to binarize the image. In some cases, an adaptive thresholding adjusts the threshold dynamically based on local image characteristics. In some cases, an edge detection may be utilized to identify abrupt changes in intensity or color in an image, which often correspond to object boundaries. Techniques such as the Canny edge detector or Sobel operator may be used to detect edges and extract object contours.

Additionally, or alternatively, the extent of objects or elements within an image can be determined by employing an MLM trained to recognize specific categories of objects or elements. For instance, an MLM could be trained to identify regions within an image corresponding to any animal or person with discernible eyes, or a machine featuring wheels. It's worth noting that an MLM tailored for object identification may operate within broad categories. For instance, it may discern that the object is an animal but might not be configured to identify the specific type of animal. Similarly, the MLM could be trained to recognize a person but may not be able to determine how old is the person. Such MLM may be referred to as a foundational MLM, and system 110 may use such a foundational MLM to prepare authentic training data for training expert MLMs for identifying further details of various objects identified by the foundational MLM.

In various scenarios, the process of determining boundaries around objects or elements within the image of data record 122, as well as identifying such entities through alternative methods (e.g., semantic segmentation or line annotation), may call for a verification or assistance from a user via a suitable interface, such as interface 113 provided by system 110. For example, in one implementation, system 110 could utilize interface 113 to present users with images and offer annotation tools for defining boundaries around various objects within those images. Through this process, users annotate objects within the image by outlining their boundaries. Using these annotations user provides information to processor 111 to cause processor 111 of system 110 to identify a set of fields, such as Fields 1-4 within the data record 122.

Alternatively, or additionally, system 110 might automatically identify a set of fields within the data record 122, by identifying the extent of objects and/or elements within the image. Subsequently, through interface 113, the system could present users with potential boundaries around identified objects within the image and request confirmation of these boundaries. This interaction effectively establishes elements for annotating the image of data record 122.

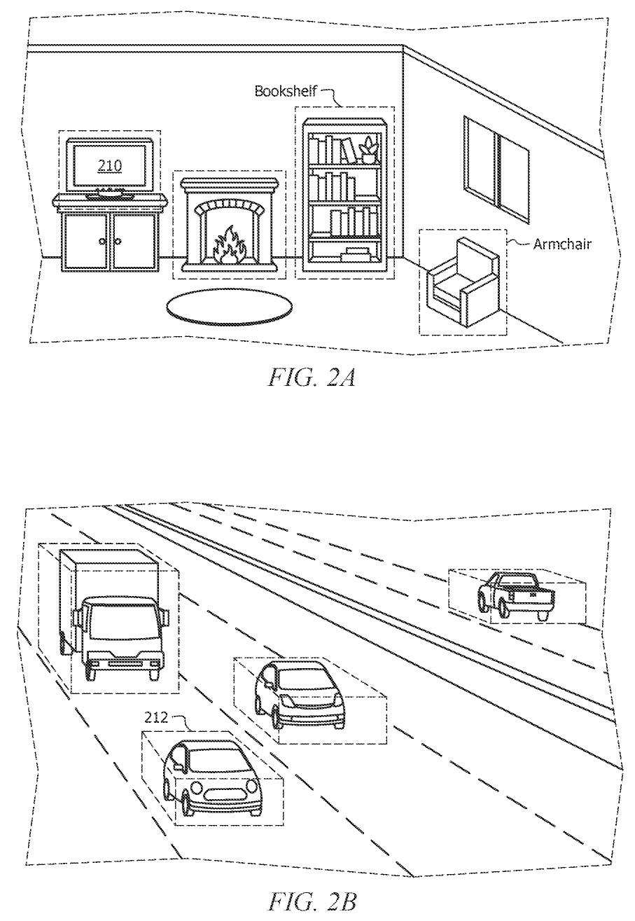

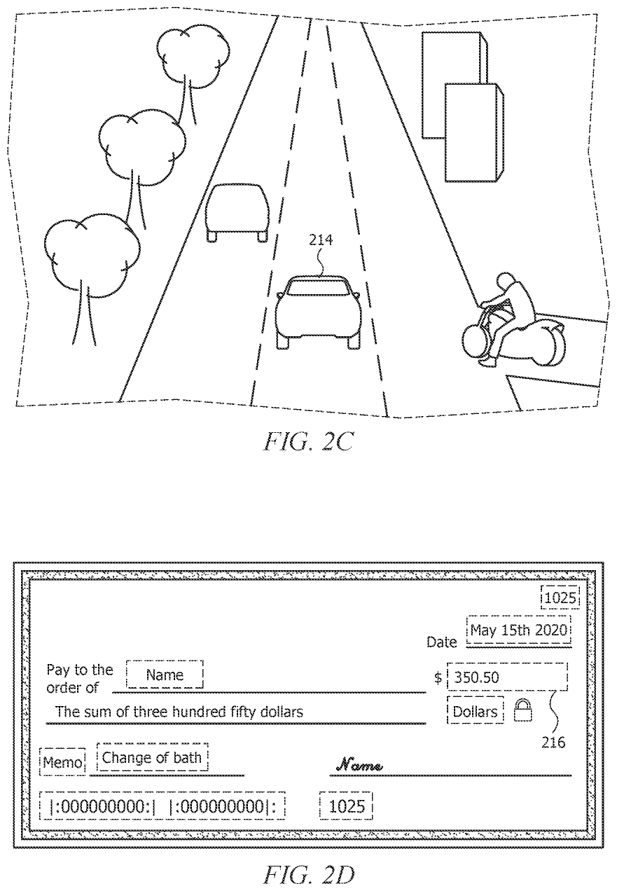

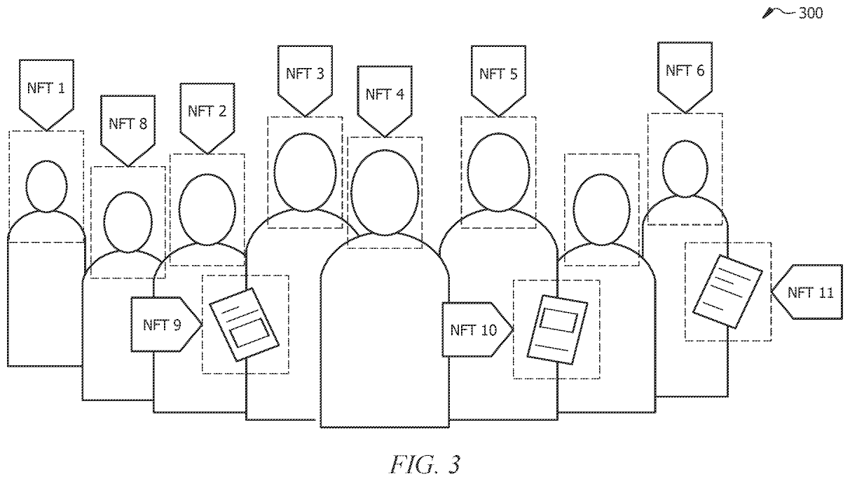

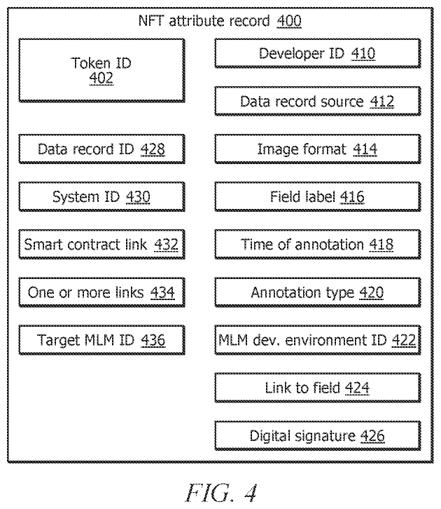

FIGS. 2A-2D and FIG. 3 show various examples of scenes with different identification methods employed for identifying different object within various images. For instance, in FIG. 2A, an image featuring a room with objects such as furniture is shown, with these objects highlighted by rectangles 210. In FIG. 2B, a scene of cars traversing a highway is presented, wherein objects are identified using cuboids 212. In FIG. 2C, objects are identified through their outlined boundaries, such as cars, a motorcycle, and individuals on the motorcycle marked by their respective outline boundaries 214. In FIG. 2D, text elements are isolated using rectangles 216. These text elements include various components typically found on a check, including the individual's name, the written and numerical amounts, the date, the check number, the account and routing numbers, and the purpose of the check, among others.

FIG. 3 shows an image 300 of a group of people with each face of a person identified by a rectangle. Additionally, various other elements within the image, beyond just the faces, are also identified using appropriately placed rectangles. FIG. 3 schematically indicates that for each field identified within image 300, an NFT (Non-Fungible Token) is generated. As shown in FIG. 3, NFT1-NFT11 tokens are generated for eleven elements, including both faces and objects, identified within image 300. In various instances an NFT can be generated for each field, as further described below. Consequently, each field can serve as an authentic training record for an MLM.

In various embodiments, processor 111 may be configured to validate the annotation by validating for, each field in the set of fields, the field metadata, where the validation of the field metadata includes comparing the field metadata with a template field metadata for a template data record. For instance, if the template data record represents a check, as illustrated in FIG. 2D, and the fields possess established labels (such as “name,” “check amount,” “routing number,” etc.), their associated metadata can be compared against the template field metadata to verify its accuracy. Furthermore, beyond label verification, the processor may validate the field metadata associated with field boundaries by comparing these boundaries with those found in the template field metadata.

In certain situations, the validation of annotations can be performed by a machine learning model (MLM) to identify valid annotations within a given set of data records. For instance, an MLM could be trained using various images resembling the one requiring annotation. It can then be tailored to provide annotations for the fields within the data record, which may involve determining field boundaries, assigning labels, and identifying other parameters such as resolution and format.

In various embodiments, a process of generating authentic training data 115 further includes annotating each one of the set of fields identified within a data record (e.g., Fields 1-4) of data record 122. The annotation includes generating for each field in the set of fields a field metadata, the field metadata including information identifying each field within the data record and a label for that field. The information identifying each field may be a field boundary, a semantic segmentation for an object associated with the field, a line annotation for that object, and the like. Furthermore, a label for a field may be any suitable label for identifying a field. For instance, in FIG. 2A, a rectangle identifying a bookshelf is labeled “Bookshelf” and a rectangle identifying an armchair is labeled “Armchair.” It should be noted that labels may be any textual values (e.g., text strings, words, phrases, numerical values, alphanumerical values, and the like).

Moreover, the field metadata may include additional information associated with a specific field. This supplementary data could include various details regarding the type of identifier utilized for field identification. For instance, it may denote whether the identifier is derived from boundary detection or semantic segmentation techniques. Furthermore, it can specify the characteristics of the boundary, such as whether it constitutes a rectangle, cuboid, partially closed curve, closed curve, polygon, outline, or similar delineations.

Further, the field metadata may include a developer identifier (ID). The developer ID may be name of a person, or an organization, or an ID of a person within an organization who contributed to identifying the field (e.g., by providing a boundary to the field). In some cases, when a developer is an algorithm such as an MLM, the developer ID may be a name of the MLM, a version of the MLM, and the like. Further, the field metadata may include a time of annotation, a system identifier (e.g., a system that was used for creating the annotation), or a target MLM identifier.

Returning to FIG. 1B, a process of generating authentic training data 115 further includes, for each field within the set of fields generating a non-fungible token (NFT), and an NFT attribute record. The NFT attribute record is configured to include information obtained from the data record metadata and the field metadata. Additionally, the NFT attribute record is configured to be stored in a memory such as memory 112. In some cases, the NFT attribute record may be stored in storage system 130. FIG. 1B shows a training record 141 of authentic training data 115 corresponding to data record 122. The training record 141 includes Fields 1-4 and associated NFTs 1-4. An illustrative NFT such as NFT4 is further shown to contain a token ID 130, a smart contract 132 and an NFT attribute record 134, all of which are further described below.

The process of generating the NFT includes developing a smart contract and initiate a minting transaction by using minting tools or a platform that interacts with a blockchain system. The initiation of the minting transaction involves sending a transaction to the smart contract with the associated metadata contained in the NFT attribute record, which is obtained from the data record metadata and the field metadata, as well as various parameters that may be used to create the NFT. Such parameters may include a token Uniform Resource Identifier (URI), which can point to the location where the token's metadata is stored (e.g., where the NFT attribute record is stored). The token URI is included in the minting transaction to reference the data record metadata and the field metadata associated with the NFT. Further, such parameters may include a receiver address which specifies a blockchain address or a wallet where the newly minted NFT will be transferred or owned. This address represents the initial owner of the NFT and can be the creator's address or any other designated address.

Following the initiation of the minting transaction, the minting transaction may be executed by executing the smart contract, thereby generating a unique token ID for the NFT and associating it with the provided NFT attribute record.

Once the minting transaction is confirmed and included in a block on the blockchain, the NFT is officially minted and recorded on the blockchain network. The token ID, NFT attribute record, and ownership information are stored securely on the blockchain, providing immutability and transparency. Further, the NFT attribute record may be appended to include information about newly generated token ID. By appending the NFT attribute record with the token ID, the NFT attribute record can be stored in a structured format (e.g., JSON) or linked in a database with the token ID as a key. When querying or interacting with a specific token, the token ID can be used to retrieve the corresponding NFT attribute record, providing users with comprehensive information about the asset represented by that specific token.

In various cases, the minted NFT can be bought, sold, or transferred on NFT marketplaces or platforms that support the chosen blockchain and NFT standard. Each transfer of ownership is recorded on the blockchain, ensuring transparency and authenticity. For example, system 110 may be configured to sell an NFT to an account associated with a particular MLM, thereby, allowing only that particular MLM to use the authentic training record associated with that NFT or perform transactions for that NFT (e.g., sell that NFT).

As explained above, the minting transaction is typically carried out by executing a smart contract associated with the NFT. This smart contract is specifically generated for a particular field from the set of fields for which the NFT is being created. In various scenarios, a smart contract can be automatically generated using a code template. These templates typically outline functions for managing tokens, transferring ownership, retrieving metadata, and conducting other common operations related to NFTs. For instance, a smart contract may include an NFT generation function that is configured to create an NFT token based on initial parameters provided, such as the token's name and a link (e.g., a URL) pointing to the NFT attribute record associated with the token. Another function of the smart contract may allow for the retrieval of metadata from the NFT attribute record linked to the token. This enables users or applications to access additional information about the NFT. Additionally, another function of the smart contact can facilitate the transfer of NFTs from one owner to another. This transfer can involve transitioning ownership rights from a first owner (possibly associated with a specific MLM) to a second owner, who may be affiliated with a different MLM. Utilizing these functions, the smart contract governs the lifecycle of NFTs, from their creation to their transfer between owners.

In various embodiments, a typical smart contract may include rules for using the field for training a machine learning model. Such rules may, for example, include a number of times the field can be used for training a target machine learning model having a target machine learning model ID, and/or an expiration time after which the field cannot be used for training the target machine learning model.

FIG. 4 displays an example NFT attribute record 400 representing a specific field extracted from an image of a data record. This record contains various metadata items (also, herein referred to as metadata records), including a token ID 402, a developer ID 410, a data record source 412, an image format 414, a field label 416, a time of annotation 418, an annotation type 420, an MLM development environment ID 422, a link to field 424, a digital signature 426, a data record ID 428, a system ID 430, a smart contract link 432, optionally one or more links 434 to various other data, and a target MLM ID 436.

Developer ID 410 may denote either a person or an algorithm responsible for identifying the field, as previously discussed. Data record source 412 could refer to a person or organization providing the image, as mentioned earlier. Image format 414 may represent any suitable format for the image, such as bitmap or vector image formats, as discussed previously. Field label 416 acts as an identifier for the field and can adopt any appropriate label for this purpose, as previously mentioned. Time of annotation 418 provides both a date and time reference for field identification and label creation, as described earlier. Furthermore, Annotation type 420 may specify various types of annotations, including boundary annotation types (e.g., rectangle, polygon, partially closed curve, closed curve, etc.), semantic segmentation, or line annotation, as previously described.

Furthermore, MLM development environment ID 422 may be any suitable identification of a development environment used for developing MLMs. For example, MLM development environment ID 422 may be a name of the MLM development environment, an URL of the development environment, or any other suitable identifier for the MLM development environment. Link to field 424 could be in the form of an URL, a file locator, or similar data, indicating the location of a field for which the NFT token is created. Various fields may be stored in any suitable memory, such as memory 112, and/or, in certain instances, they may be stored in storage system 130. These fields are linked with corresponding NFT tokens, ensuring that when an NFT token is provided, the corresponding field can be readily accessed using link to field 424.

In various embodiments, ensuring proper authentication involves storing a digital signature 426 within NFT attribute record 400. The digital signature 426 may consist of a data structure containing an encrypted hash of the field (e.g., hash of an image of an object for which the field is determined) for which the NFT token is generated. Furthermore, the data structure for digital signature 426 may specify the type of hash function used for generating the encrypted hash of the field.

Moreover, the digital signature 426's data structure includes a public key associated with a system providing authentic training data (e.g., system 110, as depicted in FIG. 1A). To authenticate the field, one or more processors of the MLM development environment may be configured to receive the field, utilize the hash function specified within the digital signature data structure to generate a test hash of the field, and then compare this test hash with a decrypted hash from the digital signature 426. The decryption process is performed using the public key. When the test hash and the decrypted hash match, the MLM development environment concludes that the digital signature 426 is authentic for the specified field and that the specified field has not been altered.

Additionally, to ensure that none of the data within NFT attribute record 400 has been tampered with during transfer to the MLM development environment, a hash function can be applied to metadata items 402, 410-424, and/or metadata items 428-436. Subsequently, after encryption, this hash data can be integrated into the digital signature 426 in a similar way as the hash for the field.

Additionally, NFT attribute record 400 may include a data record ID 428, which serves as a suitable identification (e.g., an alphanumeric ID, a name, a file location, and/or a URL) for the data record from which the associated field of the NFT attribute record 400 is extracted. Also, NFT attribute record 400 may include a system ID 430 for identifying a system for creating the NFT (e.g., system 110, as shown in FIG. 1A). System ID 430 may include a name of a system, and/or URL for the system, or any other identifier for that system. Furthermore, NFT attribute record 400 may include a smart contract link 432 for retrieving the smart contract that is used for generating and managing the NFT.

In various embodiments, processor 111 may be configured to implement various steps of generating an NFT. Alternatively, at least some of the steps for generating the NFT may be performed by a dedicated blockchain platform associated with a blockchain system. For example, processor 111 may be configured to communicate information to the blockchain platform and the blockchain platform may be configured to generate the NFT. In various cases, upon generating the NFT, the NFT may be transmitted to be recorded on the blockchain system. In some cases, processor 111 is configured to transmit the generated NFT to be recorded on the blockchain system.

As depicted in FIG. 4, NFT attribute record 400 may optionally contain one or more links 434 to various other data. For instance, these links can establish a linked list of various NFT attribute records by interlinking them. Moreover, they can link an NFT attribute record for a specific field to the data record from which that field was derived. Additionally, in certain instances, these links can connect NFT attribute records corresponding to fields obtained from a particular data record.

Additionally, NFT attribute record 400 includes target MLM ID 436, which may be any suitable identifier of an MLM. In some cases, when an MLM is registered with a system that provides authentic training data, such as system 110, a unique identifier may be provided for the MLM, and this unique identifier can be used as target MLM ID 436. Additionally, or alternatively, a unique name of an MLM may be used as a target MLM ID 436.

The target MLM ID 436 can be used for determining if the MLM associated with the target MLM ID 436 has access to authentic training data. For example, in one implementation, a processor of a system for generating authentic data, such as processor 111 of system 110, as shown in FIG. 1A is configured to receive a target MLM ID for a target MLM. Further, the processor, for a field from the set of fields, may determine, based on the NFT associated with the field, whether the field and the field metadata are authorized to be used for training the target MLM. For instance, the processor may obtain NFT attribute record corresponding for that field and compare the received target MLM ID with target MLM ID 436 within the NFT attribute record. When such IDs match, the processor may determine that the field is authorized to be used for training the target MLM.

In some cases, the processor may be configured to generate, for a data record, a field mapping of the plurality of fields having associated NFT and NFT attribute records. Upon generating such a mapping, the processor may be configured to store the field mapping in a suitable memory, such as memory 112. Additionally, or alternatively, the processor may be configured to store the field mapping in storage system 130.

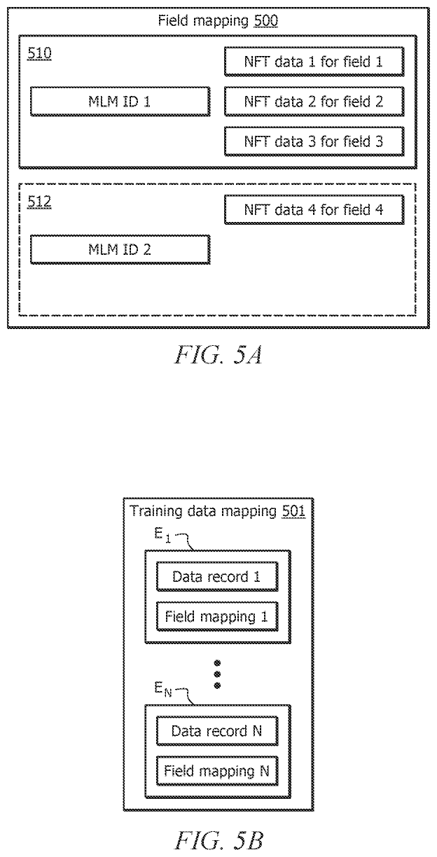

FIG. 5A illustrates an example field mapping 500 for a data record containing four fields: Field 1-Field 4 (e.g., the data record may correspond to data record 122, as shown in FIG. 1B). The field mapping 500 includes entry 510. Entry 510 includes an MLM ID 1 and a set of NFT data items such as NFT Data 1 through NFT Data 3, which can be associated with MLM ID 1. These NFT Data 1-NFT Data 3 correspond to NFTs for Fields 1-3 and provide a set of identifiers for determining which fields are suitable for training the MLM with MLM ID 1.

Optionally, field mapping 500 may incorporate another entry 512 (or several other entries) to map how another MLM with an MLM ID 2 is associated with another set of NFT data items such as NFT Data 4, corresponding to the NFT for Field 4. While NFT Data 1 through NFT Data 4 are selected to correspond to NFTs, any other identifier for Fields 1 through 4 can be utilized. For instance, field labels may be employed for mapping fields to different MLM IDs.

While FIG. 5A shows field mapping 500 for a data record, FIG. 5B shows that a similar training data mapping 501 may be constructed for several data records. For example, training data mapping 501 may include multiple mapping entries E1-Ex, with each entry corresponding a data record and its associated field mapping. For example, entry E1 corresponds to data record 1 and field mapping 1, while entry Ex corresponds to data record N and its associated field mapping N.

In an example embodiment, when generating training data mapping 501, a processor may be configured to identify a first set of fields within a first data record and a second set of fields within a second data record. In various cases, the first data record may have associated first data record metadata, and the second data record may have its own associated second data record metadata. The processor is further configured to create annotations for the first and the second set of fields by generating, for each field in the first and the second set of fields, corresponding first and second field metadata. These metadata sets include information identifying each field within the first and the second data record, as well as a label for that field.

Additionally, for each field in the first or the second set of fields, the processor is configured to generate a corresponding NFT and create an NFT attribute record. This record includes information obtained from the first or the second data record metadata and the corresponding first or the second field metadata. Furthermore, the processor may transmit the generated NFTs to be recorded on a blockchain and store the generated NFT attribute records in memory (e.g., memory 112 or storage system 130).

Moreover, the processor may generate a first and second field mapping for the first and second set of fields having associated NFTs and NFT attribute records. Additionally, it may generate a training data mapping comprising information about the first data record and its associated first field mapping, as well as the second data record and its associated second field mapping. Further, the processor may store the training data mapping in memory.

In some cases, the processor is further configured to receive the training data mapping, receive a target MLM ID for a target NLN, and select, based on NFTs associated with a plurality of fields listed within the training data mapping, fields having corresponding field metadata, that are authorized to be used for training the target MLM.

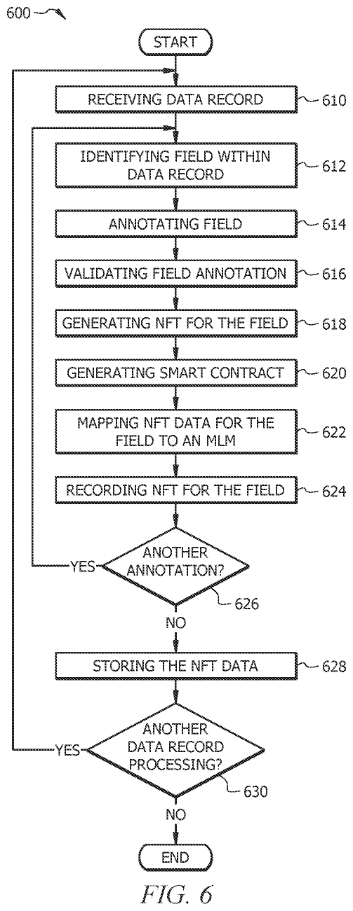

FIG. 6 illustrates an example flowchart of method 600 for generating authentic training data. Modifications, additions, or omissions may be made to method 600, which may include more, fewer, or other operations. Operations may be performed in parallel or in any suitable order. For instance, one or more operations of method 600 may be implemented, at least in part, as software instructions stored on non-transitory, tangible, computer-readable medium (e.g., memory 112) that, when executed by one or more processors (e.g., processor 111), cause the processor(s) to perform operations 610-630.

Method 600 begins with step 610, where a data record is received, followed by step 612, which involves identifying a field within the data record. The field may be identified in any suitable manner as previously discussed, such as by determining its boundaries. At step 614, method 600 annotates the field by assigning a field label and may optionally verify the field annotation at step 616 by comparing it with a template annotation for a similar data record.

Next, at step 618, method 600 generates an NFT for the field using an NFT generation approach, as discussed earlier. This process involves creating an NFT attribute record based on metadata obtained from the data record and the identified field. Subsequently, at step 620, method 600 generates a smart contract, possibly based on a template smart contract.

Additionally, method 600 may include an optional step of mapping NFT Data for the field to a MLM that can be identified by a target MLM ID as described by the field mapping depicted in FIG. 5A. At step 624, the NFT for the field is recorded on a blockchain. Method 600 then determines at step 626 if another annotation is preferred or needed for the received data record. If not (step 626, No), method 600 proceeds to step 628 to store the NFT data. Otherwise, (step 626, Yes) it returns to step 612 to identify a new field within the data record. After completing step 626, if another data record may to be processed (step 630, Yes), method 600 returns to step 610 to receive another data record. Alternatively, if another data record may not be processed (step 630, No), method 600 may complete.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112 (f) as it exists on the date of filing hereof unless the words “means for” or “step for” are explicitly used in the particular claim.

1. A system, the system comprising:
a memory configured to store a data record and metadata associated with the data record; and
a processor operably coupled to the memory, the processor configured to:
identify a set of fields within the data record;
annotate each one of the set of fields by generating for each field in the set of fields a field metadata, the field metadata comprising:
information identifying each field within the data record; and
a label for that field;
for each field:
generate a non-fungible token (NFT);
generate an NFT attribute record including information obtained from the data record metadata and the field metadata; and
store in the memory the NFT attribute record.

2. The system of claim 1, wherein the processor is further configured to transmit the NFT to be recorded on a blockchain.

3. The system of claim 1, wherein the data record metadata includes at least one of a data record source information, a data record identifier (ID), a data record file size, or a date and time when the data record was created.

4. The system of claim 2, wherein the data record is an image, and the data record metadata includes at least one of an image format, an image resolution, a color depth, a location description corresponding to the image, image creator details, or keywords associated with the image.

5. The system of claim 1, wherein the field metadata further comprises a developer ID, a time of annotation, a system ID, and a target machine learning model ID.

6. The system of claim 1, wherein the processor is further configured to validate the annotation by validating for each field in the set of fields, the field metadata, wherein the validation of the field metadata includes comparing the field metadata with a template field metadata for a template data record.

7. The system of claim 1, wherein the processor is further configured to validate the annotation, wherein the validation is performed by a machine learning model trained to identify valid annotations within a given set of data records.

8. The system of claim 1, wherein the processor is further configured to, for a field from the set of fields, generate a smart contract associated with the NFT for the field, the smart contract comprising rules for using the field for training a machine learning model, wherein the rules include at least one of:
a number of times the field can be used for training a target machine learning model having a target machine learning model ID; or
an expiration time after which the field cannot be used for training the target machine learning model.

9. The system of claim 1, wherein the data record is an image, and for a field in the set of fields, the information identifying the field comprises one of a semantic segmentation or a line annotation.

10. The system of claim 1, wherein the data record is an image, and for a field in the set of fields, the information identifying the field comprises a boundary for the field, the boundary configured to separate pixels defining a portion of the image comprising the field from pixels defining a portion of the image not comprising the field.

11. The system of claim 10, wherein the boundary is one of a rectangle, a cuboid, a polygon, or a closed curve.

12. The system of claim 10, wherein for a field in the set of fields, the NFT attribute record for the field includes at least one of a data record source information, a data record ID, a developer ID, a time of annotation, a system ID, a target machine learning model ID, the label for the field, the boundary for the field, a link to a location in the memory storing the data record; or a smart contract associated with the NFT.

13. The system of claim 12, wherein for a field in the set of fields the NFT attribute record further includes a digital signature for a developer using a hash of image data for the field.

14. The system of claim 1, wherein the processor is further configured to:
receive a target machine learning model ID for a target machine learning model; and
for a field from the set of fields, determine, based on the NFT associated with the field, whether the field and the field metadata are authorized to be used for training the target machine learning model.

15. The system of claim 1, wherein the set of fields comprises a plurality of fields, and wherein the processor is further configured to:
generate, for the data record, a field mapping of the plurality of fields having associated NFT and NFT attribute records; and
store the field mapping in the memory.

16. The system of claim 15, wherein the data record is a first data record, and the field mapping is a first field mapping, the processor is further configured to:
receive at least a second data record, the second data record including associated second data record metadata;
store the second data record in the memory;
identify a second set of fields within the second data record;
annotate each one of the second set of fields by generating for each field in the second set of fields a field metadata, the field metadata including information identifying each field within the second data record, and a label for that field;
for each field in the second set of fields:
generate an NFT;
generate an NFT attribute record including information obtained from the second data record metadata and the field metadata;
transmit the NFT to be recorded on a blockchain; and
store in the memory the NFT attribute record;
generate, for the second data record, a second field mapping of the second set of fields having associated NFTs and NFT attribute records; and
generate, a training data mapping including information about:
the first data record and the associated first field mapping, and
the second data record, and the associated second field mapping; and
store the training data mapping in the memory.

17. The system of claim 16, wherein the processor is further configured to:
receive the training data mapping;
receive a target machine learning model ID for a target machine learning model; and
select, based on NFTs associated with a plurality of fields listed within the training data mapping, fields having corresponding field metadata, that are authorized to be used for training the target machine learning model.

18. A method for authenticating a training data, the method comprising:
identifying a set of fields within a data record;
annotating each one of the set of fields by generating for each field in the set of fields a field metadata, the field metadata comprising:
information identifying each field within the data record; and
a label for that field;
for each field:
generating a non-fungible token (NFT);
generating an NFT attribute record including information obtained from data record metadata associated with the data record and the field metadata; and
storing in a memory the NFT attribute record.

19. The method of claim 18, further comprising transmitting the NFT to be recorded on a blockchain.

20. A non-transitory computer-readable medium storing instructions that, when executed by one or more processors, cause the one or more processors to:
identify a set of fields within a data record;
annotate each one of the set of fields by generating for each field in the set of fields a field metadata, the field metadata comprising:
information identifying each field within the data record; and
a label for that field;
for each field:
generate a non-fungible token (NFT);
generate an NFT attribute record including information obtained from data record metadata associated with the data record and the field metadata; and
store in a memory the NFT attribute record.
